(19) United States
(12) Patent Application Publication
(10) Pub. No.: US 2003/0052962 A1
(43) Pub. Date: Mar. 20, 2003

(54) Video communications device and associated method

(76) Inventor: Peter J. Wilk, New York, NY (US)

Correspondence Address: COLEMAN SUDOL SAPONE, P.C., 714 Colorado Avenue, Bridgeport, CT, 06605-1601, US

(21) Appl. No.: 09/952,831

(22) Filed: Sep. 14, 2001

(51) Int. Cl. H04N 7/14

(52) U.S. Cl. 348/14.01

(57) ABSTRACT

A communications device such as a portable videophone includes a video camera and monitor disposed on a frame. An object selector is operatively linked to the monitor for selecting an object in an image displayed on the monitor. An image tracker is operatively coupled to the object selector and the camera for retaining an image of the selected object encoded in a video signal from the camera during subsequent relative motion of the object and the camera.

### BACKGROUND OF THE INVENTION

This invention relates to a communications device. More specifically, this invention relates to a video communications device. This invention also relates to an associated methodology.

Two-way wireless video communications has long been a gleam in the eye of the future. In the comic strip entitled “Dick Tracy,” the main character sported a so-called two-way wrist radio which eventually became a two-way wrist TV. Needless to say, this fantasy never became reality. However, the fantasies of our future have arrived. Digital or solid state cameras, e.g., charge-coupled devices, have been greatly reduced in size and power requirements. Batteries have also decreased in weight and size while increasing in power output. Video monitors have likewise experienced a miracle of miniaturization. Other components which are necessary for a two-way video phone have also been developed, for instance, powerful computers which are small and lightweight.

The problem is to devise a video communications device which is functional for everyday purposes.

### OBJECTS OF THE INVENTION

A general object of the present invention is to provide a telecommunications device.

It is another object of the present invention to provide an improved video signal generating system and/or method.

A more specific object of the present invention is to provide such a system and/or method which facilitates video communications between two or more parties.

These and other objects of the present invention will be apparent from the drawings and descriptions herein. It is to be noted that every embodiment of the invention is believed to achieve one or more of these objects. However, it is not considered necessary for even one embodiment of the invention to achieve all of these objects.

### SUMMARY OF THE INVENTION

A communications device comprises, in accordance with the present invention, a frame, a video camera disposed on the frame, a video monitor or screen operatively connected to the video camera for displaying an image captured by the camera, an object selector operatively linked to the monitor or screen for selecting an object in an image displayed on the monitor, and an image tracking mechanism operatively coupled to the object selector and the camera for retaining an image of the object encoded in a video signal from the camera during subsequent relative motion of the object and the camera.

Pursuant to the present invention, a user selects an object for continued retention in a video signal so that the object remains on a video monitor even though the object is moving relative to the camera. Thus, there is a latching on to the selected object by the video signal generating system.

The selecting user may be the operator of the camera. In that case, the video monitor is attached to the camera as part of a video camera assembly. Alternatively, the selection may be made by a remote user. In that case, the monitor or screen is located remotely relative to the video camera, with an operative connection of the monitor or screen to the video camera via a cable or a wireless link. The remote location may be within the same room or otherwise within visual sight of the operator of the camera. Alternatively and more typically, the remote location is outside the range of direct visual contact between the operator of the camera and the viewer of the video monitor. The communications device in this case is part of a long-distance communications system.

It is to be noted that the present invention is adapted mainly to use in two-way video communications. However, the selection of an object and the automatic tracking thereof in response to the selection is also beneficial in the operation of a video recorder. The present invention assists the camera operator in following a moving subject, whether that subject is a natural phenomenon such as human being or an animal or an artificial entity such as an automobile, a kite, a motorized toy, etc.

Pursuant to another feature of the present invention, the object selector includes an image cropping mechanism for selecting a portion of an image displayed on the monitor or screen, an image of the object being located in the portion of the image. Concomitantly, the object selector comprises an object recognition component connected to the cropping mechanism for determining the presence of the object in the portion of the image. Where the object selector includes a computer, the object recognition component includes a pointer or cursor generating device (e.g., a mouse) operatively tied to the computer, while the computer is programmed to detect an object pointed to by the pointer or cursor. The object recognition component may include a computer programmed with pattern recognition software to recognize objects in a cropped area.

In accordance with a further feature of the present invention, the image tracking mechanism includes a servomechanism operatively connected on one side to the frame and on another side to an optical element for shifting the optical element. The optical element may be the camera or, alternatively or additionally, a lens, a mirror, or a prism. The image tracking mechanism typically incorporates a programmed general purpose computer for monitoring motion of a selected object in a series of video frames and using this feedback to operate the servomechanism.

In accordance with an alternative or supplemental feature of the present invention, the camera is provided with a wide angle lens, while the image tracking mechanism includes a signal processor for generating the video signal from a portion of an optical input captured and transmitted by the lens. The signal processor thus effectuates an automatic cropping of incoming image frames to delete extraneous background and move the image of the selected object to a presented position (e.g., centered) in each video frame. It is contemplated that the signal processor is a digital computer.

In accordance with a specific embodiment of the present invention, the frame of the communications device is mounted to a wrist band, while the device further comprises a wireless transmitter operatively linked to the camera and the image tracking mechanism for wirelessly transmitting the video signal to a remote location. In this embodiment of the invention the communications device preferably takes the form of a two-way portable videophone which incorporates elements for receiving and transmitting video signals, including, for instance, acoustoelectric transducers or microphones and electroacoustic transducers or speakers, as well as conventional hardware and programmed processors for voice sensing, transmission and reproduction. In this case, the video monitor or screen is also mounted to the wrist band.

A communications method comprises, in accordance with the present invention, operating a video camera to generate a first video signal of a selected scene including a plurality of objects, feeding the first video signal to a video monitor or screen to display the scene on the monitor or screen, producing a control signal designating a selected one of the objects during the display of the scene on the monitor or screen, thereafter generating a second video signal of a changing scene including an encoded image of the selected object in a predetermined substantially fixed video frame location, and automatically maintaining the encoded image of the selected object in the predetermined video frame location in the second video signal even during relative movement of the camera and the selected object.

The camera may be a portable video camera, so that the method naturally entails moving the camera to a position to record the selected scene and the changing scene. The method may further comprise wirelessly transmitting the second video signal to a destination remote from that position.

The predetermined video frame location is exemplarily a centered location in a video frame. However, the predetermined location in a video frame may be in another position, off center.

In accordance with yet another feature of the present invention, the producing of the control signal includes monitoring the location of a cursor or pointer on the monitor or screen. Alternatively, the producing of the control signal includes detecting an area cropped out on the monitor or screen by a user and processing signal data encoding images of objects in the area to detect the selected object among the objects in the area.

In at least one embodiment of the present invention, the second video signal encodes a cropped portion of a wide angle image encoded in a third video signal. In that case, the maintaining of the encoded image of the selected object in the predetermined video frame location includes processing the third video signal to extract the cropped portion of the wide angle image from the third video signal.

Alternatively, the maintaining of the encoded image of the selected object in the video frame includes operating a servomechanism to shift an optical element in an optical image capture assembly including the camera.

A communications device comprises, in accordance with another embodiment of the present invention, a video signal generator including a video camera and a video monitor, the video signal generator being operatively linked to the monitor for displaying an image of a scene on the monitor. The communications device additionally comprises means such as a wrist band a sling, a belt, or a shoulder harness, for attaching the video signal generator and the monitor to a person. A wireless transmitter is operatively connected to the video signal generator for transmitting a first video signal from the video signal generator to a remote location. A wireless receiver is operatively connected to the video monitor for receiving a second video signal from the remote location and delivering the second video signal to the monitor for displaying a video image from the remote location on the monitor. The video signal generator includes an object selector operatively linked to the monitor for selecting an object in the image of the scene displayed on the monitor and further includes an image tracking mechanism operatively coupled to the object selector and the camera for retaining an image of the object encoded in the first video signal during relative motion of the object and the camera.

As discussed above, the object selector may include an image cropping mechanism for selecting a portion of the image of the scene displayed on the monitor, where an image of the object is located in the selected portion of the image. Concomitantly, the object selector also includes an object recognition component connected to the cropping mechanism for determining the presence of the object in the selected portion of the image.

Where the object selector includes a computer, the object recognition component may include a pointer or cursor generating device operatively tied to the computer, the computer being programmed to detect an object pointed to by the pointer or cursor. Alternatively or additionally, the object recognition component may be implemented by pattern recognition software to enable the computer to recognize objects in a cropped area.

The present invention serves to eliminate a problem inherent in a two-way video communications system where one or more cameras are portable and carried by an individual at the time of signal transmission. Where a camera is carried on the wrist of a user, the invention serves to maintain a centered image of the user on the video monitor or display of another individual. The selection of the image to be centered in a series of video frames comprising a communications session or a part thereof may be undertaken by the transmitting user or the receiving user. In the latter case, the communications system is programmed to communicate the selection from the receiving station back to the transmitting station.

The present invention is also useful in video movies, for instance, home video movies, where the user wishes to follow a subject such as a running child.

### BRIEF DESCRIPTION OF THE DRAWINGS

FIG. 1 is a block diagram of a communications system utilizing a communications device and associated method in accordance with the present invention.

FIG. 2 is a schematic cross-sectional view of a communications device utilizable in the communications system of FIG. 1.

FIG. 3 is a block diagram of functional components of the device of FIG. 2.

### DEFINITIONS

The term “object selector” is used herein to denote communications system componentry which functions to isolate or define a part of a video image which corresponds to an object in the external world. Generally, objects are selected by this componentry in response to operator input. Thus, a human user provides an indication of a desired object to the hardware and/or software of the object selector. An object selector as described herein typically comprises a combination of optical and semiconductor hardware components controlled by programming to recognize the indication by the user and to derive an electronic characterization of the selected object which is used for object tracking.

The term “image tracking mechanism” as that term is used herein designates communications system componentry which functions to maintain an image of a selected object in a series of successive video frames despite a movement of the selected object relative to a video camera aimed generally in the direction of the selected object. More particularly, an image tracking mechanism as disclosed herein comprises hardware and/or software cooperating with one another to maintain an image of the selected object in a preselected location in the series of video frames, for instance, in a centered position in each of the successive video frames.

The term “image cropping mechanism” refers herein to video processing hardware and/or software which cofunctions to select, in response to user input, a portions of a video frame. Typically, a selected video frame portion is a rectangular area.

The term “object recognition means” or “object recognizer” denotes herein any combination of hardware and software which functions to detect an object in an encoded video image. Generally, object recognition means or object recognizer may comprise pattern recognition software for separating out the image of an object as foreground from an image of background. Object recognition means as disclosed herein may cooperate with a user to facilitate the identification of an object. For instance, after a user points to a desired object or crops out an area in a video image containing the desired, the object recognition componentry may highlight an object on a video image and require the user to confirm that the highlighted object is the selected object. The highlighting may be implemented by generating an outline about the object in the video image or by changing the contrast value or color of the object.

### DETAILED DESCRIPTION OF THE PREFERRED EMBODIMENTS

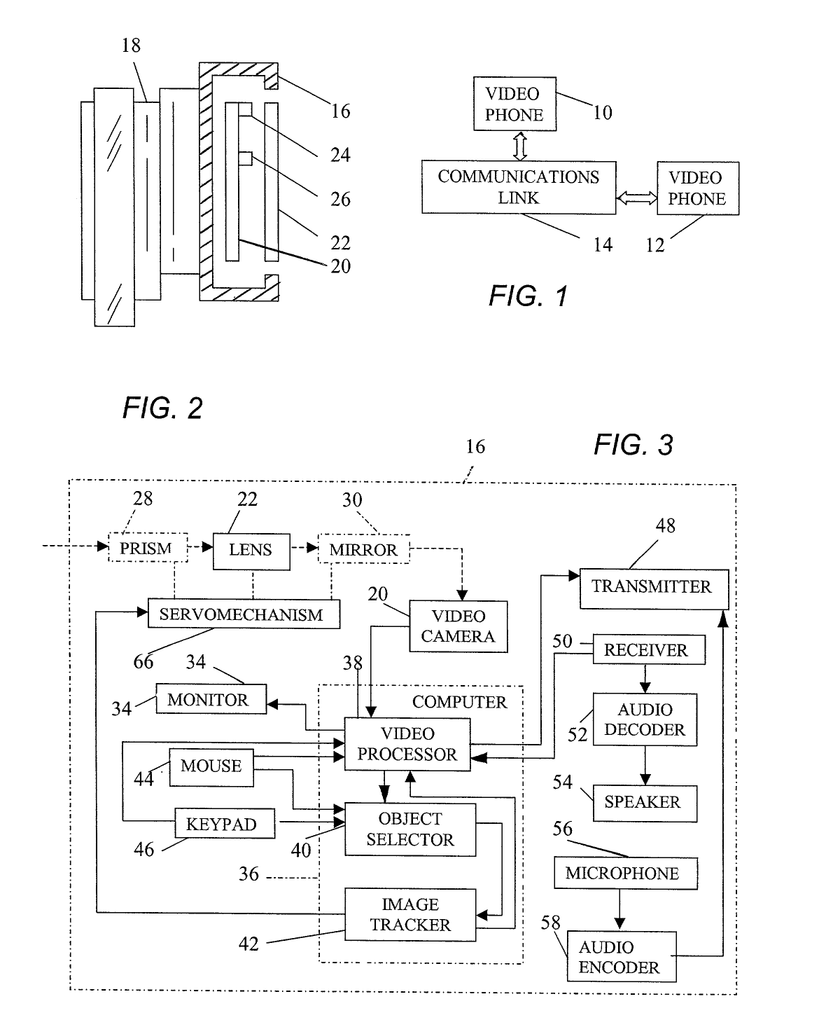

As illustrated in FIG. 1, a video communications system includes a pair of videophones 10 and 12 operatively connected to one another via a bidirectional communications link 14. Link 14 may be a wireless or a cable link. Videophones 10 and 12 may be located in the same room, different rooms in the same building, different buildings, or different cities. The videophones 10 and 12 each capture the image of a respective user at one end of communications link 14 and transmit the image of that user, as well as audio signals encoding speech of the user, to the other videophone 12 or 10 via link 14. The present disclosure is directed in part an image capture and processing technique which presents a steady and centered image of each user to the other.

As illustrated in FIG. 2, each videophone 10 and 12 comprises a frame or casing 16 attachable to the wrist of the user via a wristband 18. Casing 16 carries a solid-state video camera 20 such as a charge-coupled device and other optical elements such as a lens 22. Lens 22 is optionally connected to casing 16 via at least two extensible elements 24 and 26 such as solenoids by which the angular orientation of the lens about two mutually orthogonal axes may be continuously adjusted to track a selected object in a field of view of the camera 20.

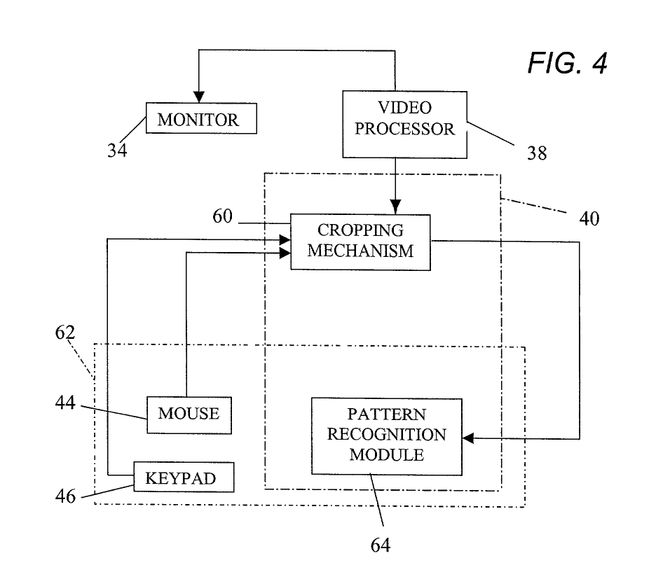

As depicted in greater detail in FIG. 3, each videophone 10 and 12 may include additional optical elements such as a prism 28 and/or a mirror 30 for focusing incoming light rays 32 on video camera 20. Also mounted to frame or casing 16 is a video monitor or display screen 34. In one configuration of the device, monitor 34 is operatively connected to video camera 20 for displaying an image captured by the camera. Thus, a user operating one videophone 10 may view an image of himself or herself as that image would be presented to another user via the other videophone 12.

As further depicted in FIG. 3, videophones 10 and 12 each include an on-board computer or microprocessor 36. Computer 36 is a generic digital device modified by programming to perform, inter alia, the functions of a video processor 38, an object selector 40 and an image tracker 42. Object selector 40 is operatively linked to video processor 38, as well as to manually operable input devices such as a mouse 44 and a keypad 46, for selecting, in response to user input, an object in an image displayed on the monitor. Object selector 40 receives the image data transmitted to monitor 34 by video processor 38 and processes the image data to recognize and encode an object selected by a user via mouse 44 and/or keypad 46. Object selector 40 is connected to image tracker 42 for identifying the selected object to that component. Image tracker 42 is also operatively coupled to camera 20 via video processor 38 for retaining an image of the selected object encoded in a video signal from the camera during subsequent relative motion of the object and the camera. Preferably, image tracker 42 retains an image of the selected object in a predetermined location (within manufacturing tolerances) in each successive video frame of a video session. Object selector 40 may be software enabled to select not only an object but also a video frame location in response to user input. Thus, a user of a videophone 10 might wish to present his or her image in a comer of an image transmitted to a user of videophone 12. The remaining portion of the image might be reserved for background that the first user wishes to discuss with the second user. One of ordinary skill in the camera arts may include optical elements and control for optimizing focus of foreground and background objects in a captured, processed and transmitted image.

As discussed above, the selecting of an object to be tracked may be executed by the operator of the local or transmitting videophone 10. Alternatively, a user at the remote or receiving videophone 12 may execute the object selection and/or image tracking. In that case, an initialization video signal is transmitted from local videophone 10 to remote videophone 12. At the remote videophone 12, a receiver 50 directs the incoming video signal to the respective video processor 38 for display on the respective monitor 34. In response to input by the remote user, the object selector 40 of the remote videophone 12 selects an object (and optionally video frame location) from the local station for display on remote monitor 34 during an ensuing video communications session between local videophone 10 and remote videophone 12.

Thus, the function of object selector 40 may be performed on either a local videophone 10 or a remote videophone 12. In the latter case, the remote videophone 12 may transmit a signal to the local videophone 10 advise the same as to the object selected. The local videophone 10 may then perform the tracking function. Alternatively, at least where the transmitted image is of a wide angle or panoramic view, the remote videophone 12 may perform both object selection and image tracking functions to ensure that a well positioned and stabilized image is present on the monitor 34 of the remote videophone 12. The local videophone 10 need not be informed as to the object selection.

Accordingly, it is to be understood that the function of image tracker 42 may be implemented on a video signal after reception thereof by a videophone 10 or 12 or prior to transmission thereof from the other videophone 12 or 10. In the former case, tracking can be implemented only through software-controlled cropping of the incoming video signal. The video signal must be a panoramic or wide-angle view to ensure, as far as possible, that the selected object is found in the transmitted video frames. In the latter case, where tracking function is performed at the transmitting station, the tracking may be accomplished through software cropping and/or via optical and mechanical adjustments.

As illustrated in FIG. 3, videophones 10 and 12 also include an audio decoder 52 operatively connected to receiver 50 for generating an audio signal delivered to an electroacoustic transducer or speaker 54 to reproduce a voice message from a remote videophone. An acoustoelectric transducer or microphone 56 is provided for converting voice-frequency pressure waves into an electrical signal processed by an audio encoder 58 into, for instance, a digital signal for relaying by a transmitter 48 to the remote videophone. The audio signals are preferably synchronized with corresponding video signals by well-known means. (The term “video signal” may be understood to incorporate both visual image data and audio data..)

As illustrated in FIG. 4, object selector 40 includes an image cropping mechanism or module 60 for selecting a portion of an image displayed on monitor 34. The selected image portion contains an image of the selected object. Cropping mechanism or module 60 cooperates with signals from mouse 44 and/or keypad 46 to identify an area in an image on monitor 34. Object selector 40 also comprises an object recognition component 62 connected to the cropping mechanism 60 for determining the presence of an object of interest in the cropped portion of the image on monitor 34. Object selector 40 is typically implemented as programmed generic digital processing circuits of computer or microprocessor 36. The object recognition component 62 then typically includes a pointer or cursor generating device (e.g., mouse 44) operatively tied to the computer 36, while the computer is programmed to detect an object pointed to by the pointer or cursor. Object recognition component 62 typically incorporates generic digital processing circuits of computer 36 which are modified by pattern recognition software to for a pattern recognition module 64 which functions to recognize objects in an area identified by cropping mechanism 62.

In an embodiment of image tracking componentry implemented in part through hardware, image tracker 42 includes a servomechanism 66 (FIG. 3) operatively connected on one side to frame or casing 16 and on another side to an optical element such as prism 28, lens 22, mirror 30, or even camera 20 for shifting the optical element about at least one axis to effectuate a mechanical pursuit of a moving object. Servomechanism 66 may include extensible elements 24 and 26 (FIG. 2).

Lens 22, either alone, or in conjunction with other optical elements such as prism 28 and mirror 30, may be a wide angle lens for facilitating a software solution to the tracking of an object by tracker 42. In that case, image tracker 42 may be implemented as digital processing circuits of computer 36 modified by programming to generate a video output signal from a portion of an optical input captured and transmitted by the optical assembly including camera 20 and lens 22. In this embodiment of the object selection and tracking functions disclosed herein, automatic cropping of incoming image frames is effectuated to delete extraneous background and move the image of the selected object to a presented position (e.g., centered) in each video frame.

Video camera 20 is typically operated to generate a video signal of a selected scene including a plurality of objects. This video signal is fed to the local monitor 34 or alternatively to a monitor of a remote videophone to display the scene on the monitor. In response to input from a local or remote user, a control signal is generated by a local or remote object selector 40 which designates a selected one of the objects during the display of the scene on the local or remote monitor 34. Thereafter, another video signal of a changing scene is generated by the local videophone 10 or 12 which includes an encoded image of the selected object in a predetermined substantially fixed video frame location. Owing to the operation of the local or remote image tracker 42, the encoded image of the selected object is maintained in the predetermined video frame location in this subsequently generated video signal even during relative movement of the local camera 20 and the selected object.

The producing of the control signal by object selector 40 includes monitoring the location of a cursor or pointer controlled by mouse 44 and/or keypad 46 on monitor 34. Alternatively, the producing of the control signal by object selector 40 includes the operation of cropping mechanism or module 60 to detect an area cropped out on monitor 34 by a user and the processing by pattern recognition module 64 of signal data encoding images of objects in the area to detect the selected object among the objects in the area. Pattern recognition software may function, for instance, to recognize the object which is most in the foreground (overlaps all other objects. Pattern recognition module 64 may be programmed to recognize patterns of familiar types, including human faces, animals, and human figures in various postures.

In at least one embodiment of a communications device, a video signal produced by a local or remote image tracker 42 encodes a cropped portion of a wide angle image encoded in an original video signal generated by the local camera 20 and associated video processor 38. In that case, the maintaining of the encoded image of the selected object in the predetermined video frame location includes processing the original video signal to extract the cropped portion of the wide angle image from the original video signal.

Although the invention has been described in terms of particular embodiments and applications, one of ordinary skill in the art, in light of this teaching, can generate additional embodiments and modifications without departing from the spirit of or exceeding the scope of the claimed invention. For example, a videophone may be attached to a part of a user other than the wrist. A shoulder strap, neck band, belt or other carrier member may be used.

More significantly, the present invention may be used in a video camcorder to facilitate the user's following of a selected subject. In this case, the video signal is not transmitted to another videophone but instead is recorded on a local or remote storage component for subsequent playback. Of course, the camcorder is provided with a monitor for real time (and playback) viewing of a scene being photographed. The monitor is used pursuant to the present invention to provide feedback to a user in the selection of an object for automatic tracking and optionally in the selection of a location in a video frame for placing the selected object.

Accordingly, it is to be understood that the drawings and descriptions herein are proffered by way of example to facilitate comprehension of the invention and should not be construed to limit the scope thereof.

What is claimed is:

1. A communications device comprising:
a frame;
a video camera disposed on said frame;
a video monitor or screen operatively connected to said video camera for displaying an image captured by said camera;
an object selector operatively linked to said monitor or screen for selecting an object in an image displayed on said monitor; and
an image tracking mechanism operatively coupled to said object selector and said camera for retaining an image of said object encoded in a video signal from said camera during subsequent relative motion of said object and said camera.

2. The device defined in claim 1 wherein said object selector includes:
an image cropping mechanism for selecting a portion of an image displayed on said monitor or screen, an image of said object being located in said portion of said image; and
object recognition means connected to said cropping mechanism for determining the presence of said object in said portion of said image.

3. The device defined in claim 2 wherein said object selector includes a computer, said object recognition means including a pointer or cursor generating device operatively tied to said computer, said computer being programmed to detect an object pointed to by said pointer or cursor.

4. The device defined in claim 2 wherein said object recognition means includes a computer programmed with pattern recognition software to recognize objects in a cropped area.

5. The device defined in claim 1 wherein said image tracking mechanism includes a servomechanism operatively connected on one side to said frame and on another side to an optical element for shifting said optical element.

6. The device defined in claim 5 wherein said optical element is said camera.

7. The device defined in claim 5 wherein said optical element is taken from the group consisting of a lens, a mirror, and a prism.

8. The device defined in claim 1 wherein said camera is provided with a wide angle lens, said image tracking mechanism including a signal processor for generating said video signal from a portion of an optical input captured and transmitted by said lens.

9. The device defined in claim 8 wherein said signal processor is a digital computer.

10. The device defined in claim 1 wherein said frame is mounted to a wrist band, further comprising a wireless transmitter operatively linked to said camera and said image tracking mechanism for wirelessly transmitting said video signal to a remote location.

11. The device defined in claim 10 wherein said video monitor or screen is also mounted to said wrist band.

12. The device defined in claim 1 wherein said object selector includes a computer programmed with pattern recognition software to recognize selected objects.

13. A communications method comprising:
operating a video camera to generate a first video signal of a selected scene including a plurality of objects;
feeding said first video signal to a video monitor or screen to display said scene on said monitor or screen;
during the display of said scene on said monitor or screen, producing a control signal designating a selected one of said objects;
after the producing of said control signal, generating a second video signal of a changing scene including an encoded image of said selected one of said objects in a predetermined substantially fixed video frame location; and
automatically maintaining said encoded image of said selected one of said objects in said video frame location in said second video signal even during relative movement of said camera and said selected one of said objects.

14. The method defined in claim 13 wherein said camera is portable, further comprising moving said camera to a position to record said selected scene and said changing scene.

15. The method defined in claim 14, further comprising wirelessly transmitting said second video signal to a destination remote from said selected scene and said changing scene.

16. The method defined in claim 13 wherein said video frame location is a centered location in a video frame.

17. The method defined in claim 13 wherein the producing of said control signal includes monitoring the location of a cursor or pointer on said monitor or screen.

18. The method defined in claim 13 wherein the producing of said control signal includes:
detecting an area cropped out on said monitor or screen by a user; and
processing signal data encoding images of objects in said area to detect said selected one of said objects among the objects in said area.

19. The method defined in claim 13 wherein said second video signal encodes a cropped portion of a wide angle image encoded in a third video signal and wherein the maintaining of said encoded image of said selected one of said objects in said video frame location includes processing said third video signal to extract said cropped portion of said wide angle image from said third video signal.

20. The method defined in claim 13 wherein the maintaining of said encoded image of said selected one of said objects in said video frame includes operating a servomechanism to shift an optical element in an optical image capture assembly including said camera.

21. A communications device comprising:
a video signal generator including a video camera;
a video monitor, said video signal generator being operatively linked to said monitor for displaying an image of a scene on said monitor;
means for attaching said video signal generator and said monitor to a person;
a wireless transmitter operatively connected to said video signal generator for transmitting a first video signal from said video signal generator to a remote location; and
a wireless receiver operatively connected to said video monitor for receiving a second video signal from said remote location and delivering said second video signal to said monitor for displaying a video image from said remote location on said monitor,
said video signal generator including:
an object selector operatively linked to said monitor for selecting an object in the image of said scene displayed on said monitor; and
an image tracking mechanism operatively coupled to said object selector and said camera for retaining an image of said object encoded in said first video signal during relative motion of said object and said camera.

22. The device defined in claim 21 wherein said object selector includes:
an image cropping mechanism for selecting a portion of the image of said scene displayed on said monitor, an image of said object being located in said portion of said image; and
object recognition means connected to said cropping mechanism for determining the presence of said object in said portion of said image.

23. The device defined in claim 22 wherein said object selector includes a computer, said object recognition means including a pointer or cursor generating device operatively tied to said computer, said computer being programmed to detect an object pointed to by said pointer or cursor.

24. The device defined in claim 22 wherein said object recognition means includes a computer programmed with pattern recognition software to recognize objects in a cropped area.

25. The device defined in claim 21 wherein said image tracking mechanism includes a servomechanism operatively connected on one side to said means for attaching and on another side to an optical element for shifting said optical element.

26. The device defined in claim 25 wherein said optical element is said camera.

27. The device defined in claim 25 wherein said optical element is taken from the group consisting of a lens, a mirror, and a prism.

28. The device defined in claim 21 wherein said camera is provided with a wide angle lens, said image tracking mechanism including a signal processor for generating said video signal from a portion of an optical input captured and transmitted by said lens.

29. The device defined in claim 28 wherein said signal processor is a digital computer.
